(19) United States
(12) Patent Application Publication
(10) Pub. No.: US 2025/0220560 A1
(43) Pub. Date: Jul. 3, 2025

(54) SYSTEM AND METHOD FOR MANAGING ENTRY OF PLMN LIST IN A USER EQUIPMENT

(71) Applicant: Samsung Electronics Co., Ltd., Suwon-si, Gyeonggi-do (KR)

(72) Inventors: Lalith KUMAR, Bangalore (IN); Mahmoud WATFA, Staines (GB)

(21) Appl. No.: 18/851,475

(22) PCT Filed: Mar. 28, 2023
(86) PCT No.: PCT/KR2023/004119

§ 371 Date: Sep. 26, 2024

(30) Foreign Application Priority Data
Mar. 28, 2022 (IN) 202241017993
Mar. 7, 2023 (IN) 2022 41017993

(51) Int. Cl. H04W 48/16

(52) U.S. Cl. CPC H04W 48/16

(57) ABSTRACT

The disclosure relates to a 5G or 6G communication system for supporting a higher data transmission rate. The method disclosed herein includes triggering a timer of a predefined-time period for an entry of one or more PLMN-IDs associated with one or more PLMNs in the PLMN list. The method includes detecting an occurrence of a switch-on operation of the UE subsequent to an occurrence of a switch-off operation of the UE. The method includes calculating a remaining time of the timer at a time of the occurrence of the switch-off operation and determining an elapsed time between the switch-off operation of the UE and the switch-on operation of the UE. The method includes comparing the calculated remaining time and the determined elapsed time and managing the entry of the one or more PLMN-IDs in the PLMN list.

### TECHNICAL FIELD

The present disclosure generally relates to the field of wireless communication and more particularly, relates to a system and method for managing entry of a Public Land Mobile Network (PLMN) list in a User Equipment (UE).

### Background Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing Ultra-high-performance communication and computing resources.

### DISCLOSURE OF INVENTION

### Solution to Problem

One embodiment provides a method, triggering a timer of a predefined-time period for an entry of one or more PLMN-IDs associated with one or more PLMNs in the PLMN list, wherein the PLMN list corresponds to a list of PLMNs not allowed to operate at a present UE location. One embodiment provides a method, detecting, upon triggering the timer, an occurrence of a switch-on operation of the UE subsequent to an occurrence of a switch-off operation of the UE. One embodiment provides a method, eining for the timer to time out. One embodiment provides a method, determining an elapsed time between the switch-off operation of the UE and the switch-on operation of the UE. One embodiment provides a method, comparing the calculated remaining time and the determined elapsed time. One embodiment provides a method, managing the entry of the one or more PLMN-IDs in the PLMN list based on a result of the comparison.

One embodiment provides a memory and one or more processors communicatively coupled to the memory. The one or more processors are configured to execute the instructions to trigger a timer of a predefined-time period for an entry of one or more PLMN-IDs associated with one or more PLMNs in the PLMN list, wherein the PLMN list corresponds to a list of PLMNs not allowed to operate at a present UE location. The one or more processors are further configured to execute the instructions to detect, upon triggering the timer, an occurrence of a switch-on operation of the UE subsequent to an occurrence of a switch-off operation of the UE. The one or more processors are further configured to execute the instructions to calculate a remaining time of the timer at a time of the occurrence of the switch-off operation of the UE based on the predefined-time period, wherein the remaining time indicates a time remaining for the timer to time out. The one or more processors are further configured to determine an elapsed time between the switch-off operation of the UE and the switch-on operation of the UE. The one or more processors are further configured to execute the instructions to compare the calculated remaining time and the determined elapsed time. The one or more processors are further configured to execute the instructions to manage the entry of the one or more PLMN-IDs in the PLMN list based on a result of the comparison.

These and other aspects and advantages of one or more embodiments will become apparent from the following detailed description, which, when taken in conjunction with the drawings, illustrate by way of example the principles of the one or more embodiments.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates a flow diagram depicting a problem related to User Equipment's (UE's) failure in obtaining service from Public Land Mobile Networks (PLMNs), as per an existing technique;

FIG. 2 is a block diagram illustrating the UE for managing entry of a PLMN list, according to an embodiment of the present disclosure; and

FIG. 3 illustrates a flow diagram depicting a method for managing entry of the PLMN list, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### MODE FOR THE INVENTION

Generally, in 3rd Generation Partnership Project (3GPP), the Next Generation-Radio Access Network (NG-RAN) is a radio access part of 5G mobile network, which aims to provide faster data transfer speeds and lower latency. In the development of NG-RAN, 3GPP is working on improving the efficiency and capacity of the mobile network. This includes the development of new technologies and standards for satellite communications, which can be used to provide connectivity in areas where traditional cellular networks are unavailable or insufficient.

One important aspect of the NG-RAN development is the use of Public Land Mobile Networks (PLMNs), which are cellular networks that are operated by public telecommunications operators. These networks provide mobile communication services to a large number of users, using radio frequencies allocated by governments. A User Equipment (UE) stores a list of PLMNs which are prohibited from operating at a current location of the UE. Each entry on the list of prohibited PLMNs includes various information such as an identity of a PLMN that sent a message including a 5GMM cause value #78. This indicates that the PLMN is not allowed to operate at the current location of the UE via a satellite NG-RAN access technology. Additionally, if the UE has access to geographical location information, it is stored alongside the entry, indicating the location where the 5GMM cause value #78 was received via the satellite NG-RAN access technology. Moreover, a UE implementation-specific distance value can be included if the geographical location is available with the UE. It is important to note that the UE implementation-specific distance value must not be set to a value smaller than the one indicated by the network.

Further, when storing a new entry in the list of prohibited PLMNs, the UE must first delete any existing entry with the same PLMN identity. Once the new entry is added to the list, the UE starts a timer instance (hereafter called a timer) associated with the new entry with an implementation-specific value. However, the implementation-specific value may not be set to a value smaller than a timer value indicated by the network. The UE can attempt to access the PLMN mentioned in the list by deleting the respective entry via the satellite NG-RAN access technology under specific conditions. Firstly, the current location of the UE must be known, and a geographical location associated with an entry of the PLMN must be available. Furthermore, a distance from the current location of the UE must be larger than the UE implementation-specific value, this is also called a distance-based trigger. Secondly, the timer associated with the entry of the PLMN must have expired, this is called a timer-based trigger. Lastly, access to the PLMN is permitted if it is required for emergency services, as stated in 3GPP TS 23.122.

Further, the list of prohibited PLMNs may generally accommodate three or more entries, but the maximum number of entries in the list is based on implementation decisions. Additionally, one or more entries can be removed from the list under certain conditions. For example, If the UE successfully registers to the PLMN stored in the entry via the satellite NG-RAN access technology or if the timer associated with the entry expires.

Further, the UE may also delete an entry in the list of prohibited PLMNs if certain conditions are met. For example, if the current location of the UE is known, the geo-graphical location is stored for the entry of the PLMN, and the distance to the current UE location is larger than the UE implementation-specific value, the UE may delete the entry. Additionally, when the UE is switched off, the list is kept in a non-volatile memory of the UE. However, the UE may delete the list if the Universal Subscriber Identity Module (USIM) is removed, such as when changing to a new SIM card or when the device is reset.

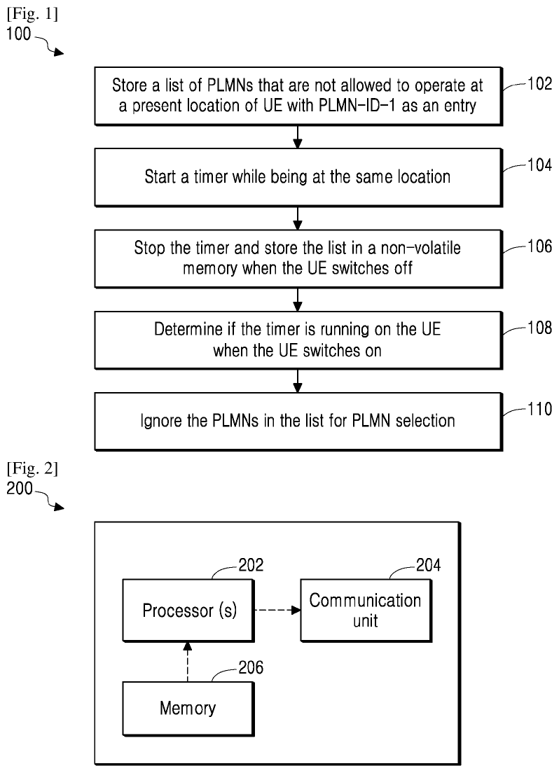

FIG. 1 illustrates a flow diagram depicting a problem related to UE's failure in obtaining service from the PLMNs, as per an existing technique. At step 102, the UE stores a list of PLMNs that are not allowed to operate at the present location of the UE with PLMN-ID-1 as an entry. At step 104, the UE starts the timer while being at the same location. At step 106, when the UE switches off also called as power off, the timer is stopped. However, the UE stores the list in the non-volatile memory. At step 108, when the UE switches on, it is determined that the timer is not running on the UE as the timer stopped before the UE is switched off. At step 110, the PLMNs remain in the list and the UE ignores the PLMNs in the list for PLMN selection purpose. That is, a timer-based trigger to delete the PLMNs from the list is not available as the timer stopped before the UE switched off. The time-based trigger is activated when the timer expires. The only mechanism to delete the PLMNs from the list is a distance-based trigger, which may not be used if the UE has not traveled the minimum distance that qualifies to delete the entry from the list. Further, if the current location of the UE is not known, the geographical location is not stored for the entry of this PLMN. This situation can result in UEs being unable to obtain the service from the PLMNs in the list on satellite NG-RAN access technology, even if the UEs are eligible, which can impact the user experience. Therefore, the UE remains in limited service impacting the user experience.

Therefore, there lies a need for a solution that can overcome each of the above-discussed problems.

Disclosed herein is a method for managing entry of a Public Land Mobile Network (PLMN) list in a User Equipment (UE). The method includes triggering a timer of a predefined-time period for an entry of one or more PLMN-IDs associated with one or more PLMNs in the PLMN list. The PLMN list corresponds to a list of PLMNs not allowed to operate at a present UE location. The method further includes detecting, upon triggering the timer, an occurrence of a switch-on operation of the UE subsequent to an occurrence of a switch-off operation of the UE. The method further includes calculating a remaining time of the timer at a time of the occurrence of the switch-off operation of the UE based on the predefined-time period. The remaining time indicates a time remaining for the timer to time out. Furthermore, the method includes determining an elapsed time between the switch-off operation of the UE and the switch-on operation of the UE. The method also includes comparing the calculated remaining time and the determined elapsed time. Further, the method includes managing the entry of the one or more PLMN-IDs in the PLMN list based on a result of the comparison.

Also disclosed herein is a UE for managing entry of a PLMN list. The UE comprises a memory and one or more processors communicatively coupled to the memory. The one or more processors are configured to trigger a timer of a predefined-time period for an entry of one or more PLMN-IDs associated with one or more PLMNs in the PLMN list. The PLMN list corresponds to a list of PLMNs not allowed to operate at a present UE location. The one or more processors are further configured to detect, upon triggering the timer, an occurrence of a switch-on operation of the UE subsequent to an occurrence of a switch-off operation of the UE. The one or more processors are configured to calculate a remaining time of the timer at a time of the occurrence of the switch-off operation of the UE based on the predefined-time period. The remaining time indicates a time remaining for the timer to time out. Additionally, the one or more processors are further configured to determine an elapsed time between the switch-off operation of the UE and the switch-on operation of the UE. The one or more processors are configured to compare the calculated remaining time and the determined elapsed time. The one or more processors are further configured to manage the entry of the one or more PLMN-IDs in the PLMN list based on a result of the comparison.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

It should be understood at the outset that although illustrative implementations of the embodiments of the present disclosure are illustrated below, the present disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features”, “one or more elements”, “at least one feature”, or “at least one element.” Furthermore, the use of the terms “one or more, “at least one”, feature, or element do not preclude there being none of that feature or element, unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

Embodiments of the present disclosure will be described below in detail with reference to the accompanying drawings.

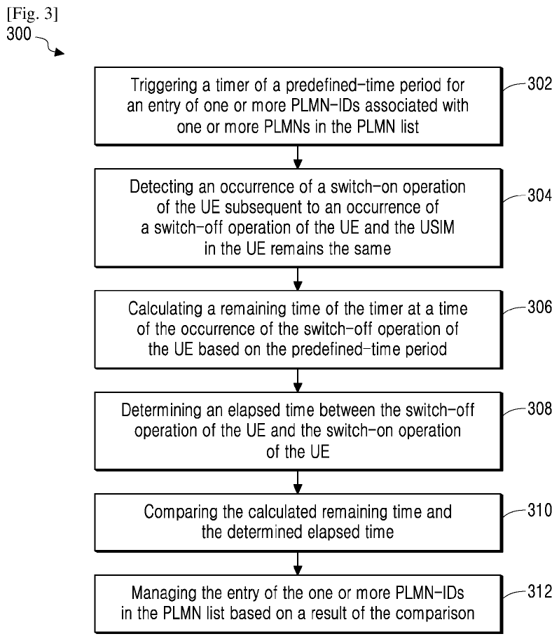

FIG. 2 is a block diagram illustrating a User Equipment (UE) 200 for managing entry of a PLMN list, according to an embodiment of the present disclosure. An example architectural configuration of the UE 200 as shown in FIG. 2 may be understood as a part of the UE configuration. Hereinafter, it is understood that terms including “unit” or “module” may refer to a unit for processing at least one function or operation and may be implemented in hardware, software, or a combination of hardware and software.

Referring to FIG. 2, the UE 200 may include one or more processors 202, a communication unit 204, and a memory 206. By way of example, the UE 200 may be an apparatus, such as a cellular phone or other devices that communicate over a plurality of cellular networks (such as a 3G, 4G, a 5G or pre-5G, 6G network or any future wireless communication network). The communication unit 204 may include a communication interface that performs functions for transmitting and receiving signals via a wireless channel of the communication interface.

As a non-limiting example, the one or more processors 202 may be a single processing unit or a number of units each including multiple computing units. The one or more processors 202 may be implemented as one or more microprocessors, microcomputers, microcontrollers, digital signal processors, central processing units, state machines, logic circuitries, and/or any devices that manipulate signals based on operational instructions (computer-readable instructions) stored in the memory 206. Among other capabilities, the one or more processors 202 are configured to fetch and execute computer-readable instructions and data stored in the memory (206). The one or more processors 202 may include one or a plurality of processors. The plurality of processors may further be implemented as a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The plurality of processors may control the processing of the input data in accordance with a predefined operating rule or artificial intelligence (AI) model stored in the memory 206. The predefined operating rule or artificial intelligence model is provided through training or learning.

The memory 206 corresponds to a non-transitory computer-readable medium known in the art including, for example, volatile memory, such as static Random-Access memory (SRAM) and dynamic random-access memory (DRAM), and/or non-volatile memory, such as read-only memory (ROM), erasable programmable ROM, flash memories, hard disks, optical disks, and magnetic tapes.

Some example embodiments disclosed herein may be implemented using processing circuitry. For example, some example embodiments disclosed herein may be implemented using at least one software program running on at least one hardware device and performing network management functions to control the elements.

According to an embodiment of the disclosure, the one or more processors 202 of the UE 200 are configured to manage an entry of the PLMN list. According to an embodiment of the disclosure, the PLMN list may also be called as ‘list’. The PLMN list corresponds to a list of PLMNs not allowed to operate at a present UE location. According to an embodiment of the disclosure, the PLMN corresponds to a network that is operated by public telecommunications operators for the purpose of providing land mobile communication services to the users. The one or more processors 202 are configured to store, in the memory 206 of the UE 200, one or more PLMN-IDs associated with one or more PLMNs in the PLMN list. According to an embodiment of the disclosure, the PLMN ID is a series of number that identifies a specific network. The PLMN ID includes a Mobile Country Code (MCC) and a Mobile Network Code (MNC).

Further, the one or more processors 202 are configured to trigger a timer of a predefined-time period for an entry of the one or more PLMN-IDs associated with the one or more PLMNs in the PLMN list. The UE starts the timer of a predefined-time period for the entry of the PLMN list, based on storing an entry of the PLMN list. According to an embodiment of the disclosure, entry of the one or more PLMN-IDs associated with one or more PLMNs in the PLMN list corresponds to addition of the one or more PLMN-IDs associated with the one or more PLMNs in the PLMN list.

According to an embodiment of the disclosure, the one or more PLMNs in the PLMN list are un-accessible by the UE 200 via satellite NG-RAN access technology until the timer is expired.

Furthermore, the one or more processors 202 are configured to detect, upon triggering the timer, an occurrence of a switch-on operation of the UE 200 subsequent to an occurrence of a switch-off operation. According to an embodiment of the disclosure, a Universal Subscriber Identity Module (USIM) of the UE 200 is the same during each of the occurrences of the switch-off operation and switch-on operation. Further, the one or more processors 202 are configured to store the PLMN list in a non-volatile memory component of the memory 206 before the occurrence of the switch-off operation. According to an embodiment of the disclosure, the UE 200 may store the PLMN list in the non-volatile memory component as the timer may stop after the switch-off operation. According to an embodiment of the disclosure, the one or more processors 202 may be configured to store information associated with the timer in the non-volatile memory component before the occurrence of the switch-off operation.

Further, the one or more processors 202 are configured to calculate a remaining time of the timer at a time of the occurrence of the switch-off operation based on the predefined-time period. According to an embodiment of the disclosure, the remaining time of the timer is calculated upon detecting the occurrence of the switch-on operation. The remaining time indicates a time remaining for the expiry of the timer.

According to an embodiment of the disclosure, the one or more processors 202 are configured to determine an elapsed time between the switch-off operation and the switch-on operation. According to an embodiment of the disclosure, the one or more processors 202 are configured to calculate the remaining time by comparing the predefined period and the determined elapsed time. Further, the one or more processors 202 are configured to compare the calculated remaining time and the determined elapsed time.

Furthermore, the one or more processors 202 are configured to manage the entry of the one or more PLMN-IDs in the PLMN list during the switch-on operation based on a result of the comparison. For managing the entry of the one or more PLMN-IDs in the PLMN list, the one or more processors 202 are further configured to determine whether the calculated remaining time is greater than the determined elapsed time based on the comparison. Further, the one or more processors 202 are configured to calculate a difference between the calculated remaining time and the determined elapsed time as a restart value when a result of the determination indicates that the calculated remaining time is greater than the determined elapsed time. Furthermore, the one or more processors 202 are configured to re-initiate the timer with the restart value. Thus, the one or more processors 202 may be configured to retain the one or more PLMN-IDs in the PLMN list until the re-initiated timer is expired. As a non-limiting example, if “t1” is the remaining for the timer to timeout at the switch-off operation, “t” is the elapsed time between the switch-off operation and the switch-on operation, and if “t1” is greater than “t”, then the timer is restarted with the value (t1−t).

Further, for managing the entry of the one or more PLMN-IDs in the PLMN list, the one or more processors 202 may also be configured to determine whether the calculated remaining time is equal to the determined elapsed time or less than the determined elapsed time based on the comparison. The one or more processors 202 are configured to terminate the timer based on a result of the determination that indicates that the calculated remaining time is equal to the determined elapsed time or less than the determined elapsed time. Furthermore, the one or more processors 202 may also be configured to remove the entry of the one or more PLMN-IDs from the PLMN list upon terminating the timer. As a non-limiting example, “t1” is the remaining for the timer to timeout at the switch-off operation, “t” is the elapsed time between the switch-off operation and the switch-on operation, and If “t1” is equal to or less than t, then the timer is terminated or considered expired.

According to an embodiment of the disclosure, the one or more processors 202 may also be configured to re-initiate the timer with a value of the calculated remaining time when the UE 200 fails to determine the elapsed time. Thus, the one or more processors 202 retains the one or more PLMN-IDs in the PLMN list until the timer is re-initiated with the value of the calculated remaining time. According to an embodiment of the disclosure, the one or more processors 202 may also be configured to re-initiate the timer with a value of the determined elapsed time when the UE 200 fails to determine the elapsed time. According to an embodiment of the disclosure, the one or more processors 202 may also be configured to terminate the timer when the UE 200 fails to determine the elapsed time.

According to an embodiment of the disclosure, the managing of the entry of the one or more PLMN-IDs in the PLMN list includes deletion of the entry of the one or more PLMN-IDs from the PLMN list when the timer is expired or terminated. Further, the one or more processors 202 may also be configured to perform a PLMN selection process to select the one or more PLMN-IDs upon the deletion of the entry of the one or more PLMN-IDs from the PLMN list. The UE may select the PLMNs following PLMN selection procedure using satellite NG-RAN access described herein for selecting the one or more PLMN-IDs. According to an embodiment of the disclosure, the PLMN selection process is a process for selecting the highest priority PLMN amongst the one or more PLMNs.

According to an embodiment of the disclosure, the one or more processors 202 may also be configured to delete one or more entries or all entries of PLMNs stored in the PLMN list after the occurrence of the switch-off operation. According to an embodiment of the disclosure, the timer may not be stopped and may continue to run even after the occurrence of the switch-off operation. Thus, there is no impact on the state of the timer during the switch-off operation. The one or more processors 202 may further terminate the timer upon expiry of the predefined time-period.

According to an embodiment of the disclosure, if the timer is expired in a time duration when the UE 200 is switched off, then the one or more processors 202 may be further configured to remove the entry of the one or more PLMN-IDs from the PLMN list when the UE 200 is switched-on.

In yet another embodiment, if the timer is not running after the occurrence of the switch-on operation, the one or more processors 202 may remove the entry of the one or more PLMN-IDs from the PLMN list when the UE 200 is switched-on.

FIG. 3 illustrates a flow diagram depicting a method 300 for managing entry of the PLMN list, according to an embodiment of the present disclosure. The method 300 as shown in the figure is implemented in the UE 200 for managing the entry of the PLMN list. The method 300 starts with step 302.

At step 302, the method 300 includes triggering a timer of a predefined-time period for an entry of the one or more PLMN-IDs associated with the one or more PLMNs in the PLMN list. The UE starts the timer of a predefined-time period for the entry of the PLMN list, based on storing an entry of the PLMN list. According to an embodiment of the disclosure, the one or more PLMNs in the PLMN list are un-accessible using satellite NG-RAN access by the UE 200 until the timer is expired. The flow of the method 300 proceeds now to step 304.

At step 304, the method 300 includes detecting, upon triggering the timer, an occurrence of a switch-on operation of the UE 200 subsequent to an occurrence of a switch-off operation of the UE 200 and the USIM in the UE remains the same. The flow of the method 300 proceeds now to step 306.

At step 306, the method 300 includes calculating the remaining time of the timer at the time of the occurrence of the switch-off operation based on the predefined-time period. The remaining time of the timer is calculated upon detecting the occurrence of the switch-on operation of the UE 200. The remaining time indicates a time remaining for the expiry of the timer. The flow of the method 300 proceeds now to step 308.

At step 308, the method 300 includes determining an elapsed time between the time of occurrence of the switch-off operation and the time of occurrence of the switch-on operation of the UE 200. The flow of the method 300 proceeds now to step 310.

At step 310, the method 300 includes comparing the calculated remaining time and the determined elapsed time. The flow of the method 300 proceeds now to step 312.

At step 312, the method 300 includes managing the entry of the one or more PLMN-IDs in the PLMN list during the switch-on operation based on the result of the comparison. For managing the entry of the one or more PLMN-IDs in the PLMN list, the method 300 includes determining whether the calculated remaining time is greater than the determined elapsed time based on the comparison. Further, the method 300 includes calculating a difference between the calculated remaining time and the determined elapsed time as a restart value when a result of the determination indicates that the calculated remaining time is greater than the determined elapsed time. Furthermore, the method 300 includes re-initiating the timer with the restart value. Thus, the one or more PLMN-IDs are retained in the PLMN list until the timer re-initiated with the restart value times out. For example, “t1” is the remaining for the timer to timeout at the switch-off operation, and “t” is the elapsed time between the switch-off operation and the switch-on operation. If “t1” is greater than “t”, then the timer is restarted with the value (t1−t).

Further, for managing the entry of the one or more PLMN-IDs in the PLMN list, the method 300 includes determining that the calculated remaining time is equal to the determined elapsed time or less than the determined elapsed time based on the comparison. The method 300 further includes terminating the timer (i.e., considered as expired) based on the determination that the calculated remaining time is equal to the determined elapsed time or less than the determined elapsed time. Furthermore, the method 300 includes removing the entry of the one or more PLMN-IDs from the PLMN list upon terminating the timer (i.e., considered as expired). For example, “t1” is the remaining for the timer to timeout at the switch-off operation, and “t” is the elapsed time between the switch-off operation and the switch-on operation. If “t1” is equal to or less than “t”, then the timer is terminated i.e., considered as expired.

According to an embodiment of the disclosure, the method 300 includes re-initiating the timer with a value of the calculated remaining time when the UE 200 fails to determine the elapsed time. Thus, the one or more PLMN-IDs are retained in the PLMN list until the timer is re-initiated with the value of the calculated remaining time. According to an embodiment of the disclosure, the method 300 includes re-initiating the timer with a value of the determined elapsed time when the UE 200 fails to determine the elapsed time. According to an embodiment of the disclosure, the method 300 includes terminating the timer when the UE 200 fails to determine the elapsed time.

According to an embodiment of the disclosure, the method 300 includes deleting one or more entries or all entries of PLMNs stored in the PLMN list at the switch-off operation. According to an embodiment of the disclosure, the timer is not stopped and continues to run after the switch-off operation. Thus, there is no impact on the state of the timer during the switch-off operation. The method 300 includes terminating the timer upon expiry of the predefined time-period.

According to an embodiment of the disclosure, if the timer expires in a time duration when the UE 200 is switched off, the method 300 includes removing the entry of the one or more PLMN-IDs from the PLMN list when the UE 200 switches ON.

According to an embodiment of the disclosure, if the timer is not running after the switch-on operation or after the switch-on operation, the method 300 includes removing the entry of the one or more PLMN-IDs from the PLMN list when the UE 200 switches ON.

The method and system disclosed herein provide various technical benefits and advantages. The technical benefits and advantages include facilitating the process of PLMN selection using the method disclosed herein for managing the entry of the one or more PLMN IDs in the PLMN list. The technical benefits and advantages further help in allowing the UE 200 to obtain the service from the PLMNs in the PLMN list on satellite NG-RAN access technology and further help in facilitating the selection of the highest priority PLMN amongst the one or more PLMNs in the PLMN list.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for managing a public land mobile network (PLMN) list by a user equipment (UE), the method comprising:
based on storing an entry of the PLMN list, starting a timer of a predefined-time period for the entry of the PLMN list, wherein the PLMN list includes at least one PLMN identity of at least one PLMN not allowed to operate at a present UE location;
while the timer is running, detecting that a switch-on operation of the UE is occurred after a switch-off operation of the UE and a Universal Subscriber Identity Module (USIM) in the UE remains the same;
in case that a remaining time t1 of the timer is greater than an elapsed time t between the switch-off operation and the switch-on operation, restarting the timer with a restart value of t1−t, wherein the entry in the PLMN list is removed in case that the re-started timer is expired; and
in case that the remaining time is equal to or less than the elapsed time, removing the entry in the PLMN list based on the timer being considered as expired.

2. The method of claim 1, further comprising:
in case that the UE is not capable of identifying the elapsed time, restarting the timer based on the remaining time.

3. The method of claim 1, further comprising:
in case that the UE is switched off, storing the PLMN list in a non-volatile memory of the UE.

4. The method of claim 1, further comprising:
in case that the USIM is removed, deleting the PLMN list.

5. A user equipment (UE) for managing entry of a public land mobile network (PLMN) list, the UE comprising:
a communication unit; and
at least one processor coupled with the communication unit and configured to:
based on storing an entry of the PLMN list, start a timer of a predefined-time period for the entry of the PLMN list, wherein the PLMN list includes at least one PLMN identity of at least one PLMN not allowed to operate at a present UE location,
while the timer is running, detect that a switch-on operation of the UE is occurred after a switch-off operation of the UE and a Universal Subscriber Identity Module (USIM) in the UE remains the same,
in case that a remaining time t1 of the timer is greater than an elapsed time t between the switch-off operation and the switch-on operation, restart the timer with a restart value of t1−t, wherein the entry in the PLMN list is removed in case that the re-started timer is expired, and
in case that the remaining time is equal to or less than the elapsed time, remove the entry in the PLMN list based on the timer being considered as expired.

6. The UE of claim 5, wherein the at least one processor is further configured to:
in case that the UE is not capable of identifying the elapsed time, restart the timer based on the remaining time.

7. The UE of claim 5, wherein the at least one processor is further configured to:
in case that the UE is switched off, store the PLMN list in a non-volatile memory of the UE.

8. The UE of claim 5, wherein the at least one processor is further configured to:
in case that the USIM is removed, delete the PLMN list.
